(19) United States
(12) Patent Application Publication
(10) Pub. No.: US 2019/0002799 A1
(43) Pub. Date: Jan. 3, 2019

(54) CONCENTRATED LIQUID DETERGENTS INCLUDING ANTIREDEPOSITION POLYMERS

(71) Applicant: BASF SE, Ludwigshafen am Rhein (DE)

(72) Inventor: Keith E. Gutowski, Royal Oak, MI (US)

(21) Appl. No.: 16/061,750

(22) PCT Filed: Dec. 9, 2016
(86) PCT No.: PCT/US2016/065705

§ 371 Date: Jun. 13, 2018

Related U.S. Application Data
(60) Provisional application No. 62/267,053, filed on Dec. 14, 2015.

(51) Int. Cl. C11D 3/00; C11D 3/04; C11D 3/37; C11D 3/43; C11D 11/00

(52) U.S. Cl. CPC C11D 3/0036; C11D 3/044; C11D 3/3765; C11D 11/0094; C11D 3/43; C11D 11/0017; C11D 11/0023; C11D 3/3749

(57) ABSTRACT

Provided herein is a concentrated liquid detergent that includes, based on the total amount of the concentrated liquid detergent, (a) 0.1 to 10 weight percent of an antiredeposition polymer, (b) 30 to 70 weight percent of at least one surfactant; (c) 5 to 69.9 weight percent of at least one additional solvent other than water; and (d) 0 to 20 weight percent water. The antiredeposition polymer (a) is a reaction product of, based on the total amount of the antiredeposition polymer, 25 to 60 weight percent of at least one (meth)acrylic acid monomer and 40 to 75 weight percent of at least one radically-polymerizable monomer.

### CROSS-REFERENCE TO RELATED APPLICATIONS

This application claims priority to U.S. Provisional Application No. 62/267,053, filed Dec. 14, 2015, the content of which is incorporated herein by reference.

### BACKGROUND OF THE INVENTION

### 1. Field of the Invention

The subject invention generally relates to concentrated liquid detergents, and more specifically, to concentrated detergents including antiredeposition polymers.

### 2. Description of the Related Art

The use of concentrated, or unit dose, liquid detergents are becoming increasingly popular for use in households over standard solid (powder or granular) laundry detergents and other liquid laundry detergents due to their ease of use and performance characteristics.

These concentrated or unit dose liquid detergents typically utilize antiredeposition polymers in amounts varying from about 0.1 to 10 weight percent. The antiredeposition polymers, as the name implies, provides antiredeposition function to the detergent—i.e., prevents redepositing of hydrophobic (for example carbon black or oils) or hydrophilic soils (for example clays) during the cleaning process, and hence improved cleaning performance on various fabrics. Typical antiredeposition polymers are formed from the polymerization of (meth)acrylic acid monomers, such as acrylic acid or methacrylic acid, and are characterized by high negative charge densities and high polarity index. As such, the antiredeposition polymers require solvation/hydration by polar solvents such as water (dielectric constant ε=78) during use.

In addition to the antiredeposition polymer, the concentrated or unit dose detergents which have low water levels, typically 0 to 20 weight percent, utilize higher levels of less polar molecular solvents and components such as 1,2-propanediol, (dielectric constant ε=32), glycerol (dielectric constant ε=42.5) and other non-ionic solvents. However, such less polar components are not compatible, or have limited compatibility, with the antiredeposition polymers due to the high charge densities present in the antiredeposition polymer.

### SUMMARY OF THE INVENTION AND ADVANTAGES

The subject invention provides concentrated liquid detergents, which include an antiredeposition polymer, at least one surfactant, and at least one solvent other than water.

In one embodiment, the subject invention provides a concentrated liquid detergent comprising, based on the total amount of the concentrated liquid detergent:
(a) 0.1 to 10 weight percent of an antiredeposition polymer comprising the reaction product of, based on the total amount of the antiredeposition polymer:
   (1) 25 to 60 weight percent of at least one (meth)acrylic acid monomer, and (2) 40 to 75 weight percent of at least one radically-polymerizable monomer having radically polymerizable groups selected from a linear α-olefin, a branched α-olefin, a styrenic monomer, a vinyl or allyl ether monomer, an ethylenic monomer, a (meth)acrylate monomer and combinations thereof;
(b) 30 to 70 weight percent of at least one surfactant; and
(c) 5 to 69.9 weight percent of at least one solvent other than water, and
(d) 0 to 20 weight percent water.

Relatedly, the subject invention also provides associated methods for forming the concentrated liquid detergents according to the embodiments provided above that includes (a) forming an antiredeposition polymer according to the embodiments described above; (b) neutralizing the formed antiredeposition polymer with a neutralizing agent; and (c) combining 0.1 to 10 weight percent of said neutralized antiredeposition polymer with 30 to 70 weight percent of at least one surfactant; 5 to 69.9 weight percent of at least one solvent other than water; and 0 to 20 weight percent water.

The concentrated liquid detergents of the subject invention can find use in low water content formulations and applications for concentrated/unit dose laundry, automatic dishwashing, manual dishwashing, and hard surface cleaning. The introduction of reaction component (2) used in forming the antiredeposition polymer (a) reduces the neutralized charge density of the antiredeposition polymer as compared with an antiredeposition polymer formed from component (1) alone. This reduced charge density increases the compatibility of the formed antiredeposition polymer (a) with components (b) and (c) (in terms of solubility and stability) in the concentrated laundry detergent without adversely affecting the antiredeposition function of the antiredeposition polymer (a) within the concentrated liquid detergent. In addition, the incorporation of the reaction component (2) reduces to the polarity of the polymer in its neutralized form.

### BRIEF DESCRIPTION OF DRAWING

FIGS. 1-3 are graphs comparing antiredeposition performance, in terms of change in color (delta E, dE), for various laundry formulations on a variety of fabrics.

### DETAILED DESCRIPTION OF THE INVENTION

The subject invention provides concentrated liquid detergents, otherwise known as unit dose or single dose liquid detergents, including antiredeposition polymers having improved compatibility with the remainder of the less polar solvent components of the concentrated liquid detergent.

The concentrated liquid detergents of the subject invention can find use in low water content formulations and applications for concentrated/unit dose laundry, automatic dishwashing, manual dishwashing, and hard surface cleaning.

The term “concentrated”, as in “concentrated liquid detergents”, refers to liquid detergents having, at most, 20% water based on the total weight of the concentrated liquid detergent. Stated another way, the “concentrated liquid detergent” of any embodiment of the subject invention includes from 0 to 20 weight percent of water, based upon the total weight of all of the components of the liquid detergent.

In a first embodiment of the subject invention, the concentrated liquid detergent comprises, based on the total amount of the concentrated liquid detergent:
(a) 0.1 to 10 weight percent of an antiredeposition polymer, the antiredeposition polymer comprising the reaction product of, based on the total amount of the antiredeposition polymer:
   (1) 25 to 60 weight percent of at least one (meth)acrylic acid monomer, and
   (2) 40 to 75 weight percent of at least one radically-polymerizable monomer having radically polymerizable groups selected from a linear α-olefin, a branched α-olefin, a styrenic monomer, a vinyl or allylic ether monomer, an ethylenic monomer, a (meth)acrylate monomer and combinations thereof;
(b) 30 to 70 weight percent of at least one surfactant; and
(c) 5 to 69.9 weight percent of at least one solvent other than water, and
(d) 0 to 20 weight percent water.

In certain instances of this first embodiment, the sum of (a), (b), (c) and (d) is 100 weight percent of the concentrated liquid detergent. Still further, in certain instances of this first embodiment, components (1) and (2) are the only components used to form the antiredeposition polymer (i.e., are the only components used to form the reaction product).

In a second embodiment of the subject invention, at least one monomer of maleic anhydride is copolymerized into the backbone with at least one monomer comprising those in components (1) and (2). When utilized, substantially all of the maleic anhydride monomers, or all of the maleic anhydride monomers, that are polymerized into the backbone are ring opened with respective hydroxide (OH—) ions and is subject to the constraint that the acid number be satisfied, as indicated in further detail below, assuming a theoretical 2 equivalents of acid per maleic anhydride monomer. The term substantially, as in substantially all as provided above, is defined herein to mean that at least 90% of the maleic anhydride monomers polymerized into the backbone are subsequently ring opened prior to the formed antiredeposition polymer being utilized in the concentrated laundry detergent.

In the first embodiment or in the second embodiment, the weight average molecular weight (M_{W}), as measured by gel permeation chromatography (GPC) previously calibrated using a calibration curve based on mono-dispersed polystyrene standards, of the antiredeposition polymer ranges from 1,000 to 100,000 g/mol (Daltons); such as from 1,250 to 30,000 g/mol, such as from 1,500 to 20,000 g/mol., such as from 1,800 to 17,250 g/mol.

Still further, in the first embodiment or in the second embodiment, the acid number of the antiredeposition polymer, prior to being mixed with any other component of the concentrated liquid detergent (such as, for example, components (b)-(d) above or other optional components described below) and prior to being neutralized with a neutralizing agent (e) (described in further detail below), ranges from 50 to 500 mg KOH, such as from 75 to 450 mg KOH, such as from such as from 150 to 425 mg KOH, such as from 200 to 400 mg KOH, such as from 205 to 372 mg KOH. The acid number, or acid value, as defined herein refers to the mass of potassium hydroxide (KOH) in milligrams that is required to neutralize one gram of the antiredeposition polymer.

In the embodiments described above, the antiredeposition polymer (a) includes, as one of the components of the formed reaction product, at least one (meth)acrylic acid monomer (1). As used herein, the term “(meth)acrylic acid monomers” refers to acrylic acid monomers, methacrylic acid monomers and mixtures of acrylic acid monomers and methacrylic acid monomers in any weight or number ratio.

The antiredeposition polymer (a), as described above, also includes at least one radically-polymerizable monomer having radically polymerizable groups (2). As used herein, the term “radically-polymerizable monomer” refers to a monomer that can be polymerized to an oligomer or to a polymer, or reacted with other monomers, via free radical chain polymerization through their respective radically polymerizable groups. A radically polymerizable group, in general, is a reactive group on the respective molecule that undergoes free radical polymerization.

Exemplary radically-polymerizable monomers (2) having radically polymerizable groups for use in this first embodiment include linear and branched (vinylidene) alpha-olefins (i.e., linear α-olefin or branched α-olefin), styrenic monomers, vinyl or allylic ether monomers, ethlyenic monomers, (meth)acrylate monomers and combinations thereof.

Linear α-olefins include, for example, C₁₆ and C₁₈ α-olefins. Branched α-olefins include, for example, isobutene and diisobutene.

Styrenic monomers include, for example, styrene and α-methyl styrene.

Vinyl or allylic ether monomers include MPEG (methoxypolyethylene glycol) allylether, of varying weight average molecular weights such as, for example, MPEG 700 (MPEG with a weight average molecular weight of about 700).

Ethylenic monomers refer to vinyl acetate, vinyl pyridine, vinyl pyrrolidone, sodium crotonate, methyl crotonate, crotonic acid, and the like, and any combination thereof.

“(Meth)acrylate monomers” refers to acrylate monomers or methacrylate monomers and mixtures thereof.

Example of suitable acrylate monomers include, without limitation, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acryl ate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate.

Examples of acrylate derivatives also include, without limitation, acrylonitrile, acrylamide, methyl α-chloroacrylate, methyl 2-cyanoacrylate, N-ethylacrylamide, N,N-diethylacrylamide and acrolein.

Examples of suitable methacrylate monomers include, without limitation, the following methacrylate esters: methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate and tetrahydropyranyl methacrylate.

Examples of other suitable methacrylate monomers also include, without limitation, methacrylate derivatives such as: methacrylonitrile, methacrylamide, N-methylmethacrylamide, N-ethylmethacrylamide, N,N-diethylmethacrylamide, N,N-dimethylmethacrylamide, N-phenylmethacrylamide and methacrolein.

In addition, the antiredeposition polymer (a) of the first embodiment may also include, as part of its reaction product, (3) at least one monomer of maleic anhydride. In these additional embodiments, the at least one monomer of maleic anhydride (3), when present, is present in an amount ranging from greater than 0 to 16 weight percent of the reaction product when used in combination with at least one monomer from component (2). When included, substantially all, if not all, of the maleic anhydride monomers polymerized into the backbone are ring opened with a hydroxide (OH—) ion contributed from the neutralizing agent and is subject to the constraint that the acid number (defined below) be satisfied, assuming a theoretical 2 equivalents of acid per maleic anhydride monomer. Again, substantially all refers means that at least 90% of the maleic anhydride monomers polymerized into the backbone are subsequently ring opened with hydroxide ions contributed from the neutralizing agent prior to the formed antiredeposition polymer being included in the concentrated laundry composition.

In each of the embodiments above, the concentrated liquid detergent further includes at least one surfactant (b).

Exemplary surfactants (b) for use in the first embodiment or the second embodiment include nonionic surfactants, anionic surfactants, cationic surfactants, amphoteric surfactants, and combinations thereof.

Exemplary nonionic surfactants that may be utilized include, but are not limited to, ethoxylates and alkoxylates based on natural (linear)- and synthetic(branched)-derived alcohols and amines with ethoxylation and/or alkoxylation ranges of 1-25 and carbon chain lengths in the range of 6-20; alkylpolyglucosides; ethylene oxide-propylene oxide (EO-PO) block copolymers (Pluronic types); EO-PE block co-polymers based on ethylenediamine (Tetronic-types); and any combination thereof.

Exemplary anionic surfactants include, but are not limited to, alkyl (linear and branched) carboxylates; ether carboxylates, sulfates; ether sulfates; dialkylsulfosuccinates; linear alkylbenzenesulfonates; methylestersulfonates; alpha-olefin sulfonates, salts thereof (including sodium, potassium, amine, and alkanolamine salts); and any combination thereof.

Exemplary cationic surfactants include, but are not limited to, synthetic amine salts; fatty amine salts; fatty diamine salts; alkyl quats; dialkylquats; ester quats; and any combination thereof.

Exemplary amphoteric surfactants include, but are not limited to, betaines such as cocobetaine; amidobetaines such as cocamidopropylbetaine; amine oxides such as lauramine oxide or cocamidopropyl amine oxide; imidazoli; and any combination thereof.

In each of the embodiments above, the total amount of surfactant (b) present in the concentrated liquid detergent may range from 30 to 70 percent, such as from 35 to 65 weight percent, such as from 40 to 60 weight percent, of the total weight of the concentrated liquid detergent.

In each of the embodiments above, the concentrated liquid detergent further includes at least one solvent (c) other than water.

Exemplary solvents (c) for use in the first or the second embodiments include non-aqueous solvents, including but not limited to, alcohols (such as ethanol), diols (such as ethyleneglycol), polyols (such as glycerine), glycols, polyalkylene glycols (low MW PEGs), such as polyethylene glycol, 1,2-propane diol (propylene glycol), 1,3-propane diol. Mixtures of these solvents are also possible, such as two-component mixtures (i.e., ethanol and propylene glycol), three-component mixtures (i.e., ethanol, glycerol, and propylene glycol), and higher-component mixtures (four-component, five-component, etc.).

In each of the embodiments above, the total amount of solvent (c) present in the concentrated liquid detergent ranges from 5 to 69.9 percent, such as from 7.5 to 30 weight percent, such as from 10 to 25 weight percent, of the total weight of the concentrated liquid detergent.

As noted above, in each of the embodiments above, the concentrated liquid detergent further may or may not include water (d) in an amount ranging from 0 to 20 percent of the total weight of the concentrated liquid detergent. In embodiments where water (d) is present, the amount of water (d) present in the concentrated liquid detergent is at most 20 percent of the total weight of the concentrated liquid detergent, such as from 0.1 to 20 percent of the total weight of the concentrated liquid detergent, such as from 6.9 to 15, or from 6.9 to 20 percent, of the total weight of the composition.

As noted above, in each of the embodiments above, the concentrated liquid detergent further includes a neutralizing agent (e) that is added to the concentrated liquid detergents in an amount sufficient to neutralize the carboxylic acid groups contributed from the (meth)acrylic acid monomers (a).

Exemplary neutralizing agents (e) that can be used include sodium hydroxide, potassium hydroxide, ammonia, ammonium hydroxide, monoethanolamine, and triethanolamine.

In still further embodiments, the concentrated liquid detergent may include additional components. Exemplary additional components include polymers (including but not limited to those for primary cleaning, secondary cleaning, soil release agents, rheology modification, softening, rejuvenation), enzymes (including but not limited to protease, amylase, mannanase, lipase, pectinase, xylo-gluconase), enzyme stabilizers (including but not limited to borates, glycols, carboxylate salts, peptide inhibitors), optical brighteners (including but not limited to distyryl biphenyl type, diamino stilbene type), chelating agents (including but not limited to EDTA, MGDA, GLDA, citrate, gluconate), other builders, hydrotropes, organic and inorganic fillers, foam boosting or suppressing agents, dyes, perfumes, light stabilizers, bleaches, bleach catalysts, and any combination thereof.

In each of the embodiments above, the introduction of reaction component (2) used in forming the antiredeposition polymer (a) reduces the charge density of the antiredeposition polymer as compared with an antiredeposition polymer formed from component (1) alone. This reduced charge density increases the compatibility of the formed antiredeposition polymer (a) with components (b) and (c) (in terms of solubility and stability) in the concentrated laundry detergent without adversely affecting the antiredeposition function of the antiredeposition polymer (a) within the concentrated liquid detergent.

The subject invention also provides associated methods for forming the concentrated liquid detergents according to any of the embodiments provided above. In general, the method according to any embodiments includes the following steps (a)-(c): (a) forming an antiredeposition polymer according to any of the embodiments described above; (b) neutralizing the formed antiredeposition polymer with a neutralizing agent; and (c) combining 0.1 to 10 weight percent of the neutralized antiredeposition polymer with 30 to 70 weight percent of at least one surfactant; 5 to 69.9 weight percent of at least one solvent other than water; and 0 to 20 weight percent water.

More specifically, in regards to the first embodiment described above, the method for forming the concentrated liquid detergent in accordance with this first embodiment includes the following steps:
(a) forming an antiredeposition polymer comprising the reaction product of:
   (1) 25 to 60 weight percent of at least one (meth)acrylic acid monomer, and
   (2) 40 to 75 weight percent of at least one radically-polymerizable monomer having radically polymerizable groups selected from a linear α-olefin, a branched α-olefin, a styrenic monomer, a vinyl or allylic ether monomers, an ethylenic monomer, a (meth)acrylate monomer and combinations thereof;
(b) neutralizing the formed antiredeposition polymer with a neutralizing agent; and
(c) combining 0.1 to 10 weight percent of said neutralized antiredeposition polymer with 30 to 70 weight percent of at least one surfactant; 5 to 69.9 weight percent of at least one solvent other than water; and 0 to 20 weight percent water.

When the antiredeposition polymer of this first embodiment includes (3) at least one monomer of maleic anhydride, step (a) of this first method is modified as follows:
(a) forming an antiredeposition polymer comprising the reaction product of:
   (1) 25 to 60 weight percent of at least one (meth)acrylic acid monomer,
   (2) 40 to 75 weight percent of at least one radically-polymerizable monomer having radically polymerizable groups selected from a linear α-olefin, a branched α-olefin, a styrenic monomer, a vinyl ether or an allylic ether monomer, an ethylenic monomer, a (meth)acrylate monomer and combinations thereof; and
   (3) at least one monomer of maleic anhydride present in an amount ranging from greater than 0 to 16 weight percent.

In this embodiment, substantially all of the maleic anhydride monomers included in the backbone after polymerization and prior to inclusion of the formed antiredeposition polymer in the concentrated liquid detergent are ring opened with a hydroxide ion (OH—) that is contributed from the neutralizing agent (b), and wherein the neutralizing agent (b) is either sodium hydroxide or potassium hydroxide or ammonium hydroxide or any combination thereof. Again, substantially all refers means that at least 90% of the maleic anhydride monomers polymerized into the backbone are subsequently ring opened with hydroxide ions contributed from the neutralizing agent (b) prior to the formed antiredeposition polymer being included in the concentrated laundry composition.

Regarding step (c) of this first method of either embodiment (with or without the inclusion of maleic anhydride), the introduction of the at least one surfactant, the at least one solvent other than water, and optionally water can be introduced sequentially in any order, or wherein two or more of these components are introduced simultaneously.

The following examples are intended to illustrate the invention and are not to be viewed in any way as limiting to the scope of the invention.

### EXAMPLES

### Example 1

### Preparation of Concentrated Laundry Formulations A-D

Concentrated laundry formulations A-D were prepared at varying concentrations in water (water ranges from 6.9 to 20 percent by weight based upon the total weight of the laundry formulations) and include the following components (product/ingredient/component) as listed in Table 1 below.

TABLE 1
Concentrated Laundry Formulations

| | Wt % active | Wt % “as supplied” | | | |
|---|---|---|---|---|---|
| Product/ingredient | material/solids | A | B | C | D |
| Propylene glycol | | 14.90 | 11.77 | 13.00 | 10.77 |
| Glycerine | | 9.00 | 9.00 | 2.77 | 0.00 |
| Monoethanolamine | | 7.33 | 7.33 | 7.33 | 7.33 |
| Linear alkylbenzene | 97 | 18.04 | 18.04 | 18.04 | 18.04 |
| sulfonic acid | | | | | |
| Coconut oil fatty | 100 | 12.50 | 12.50 | 12.50 | 12.50 |
| acid | | | | | |
| Alcohol ether sulfate | 70 | 14.29 | 14.29 | 14.29 | 14.29 |
| (3 mol) | | | | | |
| Alcohol ethoxylate | 100 | 20.00 | 20.00 | 20.00 | 20.00 |
| (6.5 mol) | | | | | |
| Optical brightener | | 0.11 | 0.11 | 0.11 | 0.11 |
| Protease enzyme* | | 0.50 | 0.50 | 0.50 | 0.50 |
| ARD polymer** | 30 | 3.33 | 3.33 | 3.33 | 3.33 |
| Water | | 0.00 | 3.13 | 8.13 | 13.13 |
| % Water | | 6.90 | 10.00 | 15.00 | 20.00 |

*Assumed 50% water
**100% active resin neutralized with 50% NaOH solution and diluted to 30% active material

The formulations of Table 1 were prepared in accordance with the procedure detailed in Table 2 below:

TABLE 2
Instructions for preparation of Formulations A-D

| | Order of | |
|---|---|---|
| Ingredient | addition | Instruction* |
| Water | 1 | — |
| Propylene glycol | 2 | Mix until homogenous |
| Optical brightener | 3 | Mix until dissolved |
| Glycerine | 4 | Mix until homogenous |
| Monoethanolamine | 5 | Mix until homogenous |
| Linear alkylbenzene sulfonic | 6 | Mix until |
| acid | | neutralized/dissolved |
| Coconut oil fatty acid | 7 | Mix until |
| | | neutralized/dissolved |
| Alcohol ethoxylate (6.5 mol) | 8 | Mix until homogenous |
| Alcohol ether sulfate (3 mol) | 9 | Mix until dissolved |
| Protease enzyme | 10 | Mix until homogenous |
| Acrylic polymer | 11 | Mix until homogenous |

*All mixing steps carried out with no additional heating

The antiredeposition (ARD) polymers included in Formulations A-D were neutralized with 50% NaOH solution and diluted to 30% active material prior to introduction to the laundry formulations A-D above. The amount of 50% NaOH solution required for neutralization of each ARD polymer was calculated based on the acid number of the ARD polymer as follows:

wt 50% NaOH, g=(wt resin, g)×(acid number)×(40.0/56100)×(1/0.5)

Solid polymer resins of the ARD polymers were used as supplied as clear flakes. The polymer flakes were first added to a round bottom flask along with approximately 80-90% of the total amount of water needed. The total amount of water (grams) needed was calculated as the amount to reach 30% solids of the final stock ARD polymer. The 50% NaOH solution was added to the round bottom flask and mixed at 50° C. until the resin was fully neutralized/dissolved. The remaining approximately 10-20% of the total amount of water was then added to achieve the final stock dilution of 30 wt %. The percent solids of each stock were verified using a Mettler-Toledo moisture balance. The final pH values of the ARD polymer stocks ranged from 6.5-8.5.

### Example 2

### Compatibility of Various ARD Polymers in Formulations A-D of Example 1

Next, in Example 2, ARD polymers having varying compositions and acid numbers were evaluated in Laundry Formulations A-D for initial compatibility (Table 3) as determined by visual appearance. Formulations were determined to be clear/transparent (C/T), which indicates that the antiredeposition polymer were compatible with the remaining components of the laundry formulation; hazy/opaque (H/O), which indicates that the antiredeposition polymer were not compatible with the remaining components of the laundry formulation; or slightly hazy (SH), which indicates that the antiredeposition polymers were had a slight degree of incompatibility. Regarding the commercial off-the-shelf product (All Mighty Pacs, available from Sun Products), this product was used as is and mixed with the representative ARD polymer and tested for compatibility in the same manner as Formulations A-D with the particular ARD polymers. The results are summarized in Table 3:

TABLE 3
Compatibility¹ Matrix for ARD Polymers for Formulations

| | | Compatibility/Appearance After ARD | | | | |
|---|---|---|---|---|---|---|
| | | Polymer Addition | | | | |
| | | (H/O = Hazy/Opaque; C/T = Clear/ | | | | |
| | | Transparent; SH = Slight Haze) | | | | |
| | Acid | | | | | Commercial |
| ARD Polymer | Number² | A | B | C | D | off-the-shelf³ |
| Polyacrylate | 778 | H/O | H/O | H/O | H/O | H/O |
| homopolymer | | | | | | |
| Acrylic polymer | 372 | H/O | H/O | C/T | C/T | H/O |
| Acrylic polymer | 347 | H/O | H/O | C/T | C/T | H/O |
| Acrylic polymer | 244 | C/T | C/T | C/T | C/T | — |
| Acrylic polymer | 240 | C/T | C/T | C/T | C/T | C/T |
| Acrylic polymer | 226 | C/T | C/T | C/T | C/T | — |
| Acrylic polymer | 222 | C/T | C/T | C/T | C/T | — |
| Acrylic polymer | 221 | C/T | C/T | C/T | C/T | — |
| Acrylic polymer | 216 | C/T | C/T | C/T | C/T | C/T |
| Acrylic polymer | 214 | C/T | C/T | C/T | C/T | — |
| Acrylic polymer | 205 | C/T | C/T | C/T | SH | — |
| Acrylic polymer | 75 | H/O | H/O | H/O | H/O | — |

¹All formulations are initially clear/transparent liquids with amber color
²Acid numbers for the ARD polymers are prior to neutralization with NaOH.
³All Mighty Pacs, available from Sun Products, having a water content of 9.4% by weight as determined by Karl Fischer titration, were mixed with the ARD polymer to determine compatibility.

As indicated in Table 3, antiredeposition polymers having monomer contents in accordance with the present invention and having acid numbers ranging from 205 to 244 were compatible in laundry formulations having water contents having water contents of 6.9 weight percent, 10 weight percent, 15 weight percent and 20 weight percent (i.e., Laundry Formulations A-D), respectively. Still further, antiredeposition polymers having monomer contents in accordance with the present invention and having acid numbers ranging of 347 and 372 were clear/transparent in laundry formulations having 15 and 20 weight percent water i.e., Laundry Formulations C and D).

By contrast, as also indicated in Table 3, the control antiredeposition polymer (an acrylic acid homopolymer having as acid number of 778 and diluted to 30% active material) was hazy/opaque at each of the four water contents of 6.9 weight percent, 10 weight percent, 15 weight percent and 20 weight percent, respectively, which suggests that its antiredeposition polymer is incompatible in these systems (i.e., Laundry Formulations A-D). Also, Table 3 also indicates that the commercial product (having a water content of about 9.4 weight percent as determined by Karl Fischer titration) was compatible with ARD polymers having monomer contents in accordance with the subject invention and acid numbers of 216 and 240, but was incompatible with ARD polymers having monomer contents in accordance with the subject invention and acid numbers of 347 and 372.

Certain of the laundry formulations from Table 3, at 10% water levels (i.e., Formulation B), that included ARD polymers which were compatible or slightly compatible in the Formulations, were also evaluated for visual stability/compatibility under varying temperature conditions (Freeze/Thaw, Room Temperature, 4° C., 50° C.) to confirm their compatibility over time (in Table 4, for three weeks). The results are summarized in Table 4 below:

TABLE 4
Formulation B (10% water) stability after 3 weeks
(Freeze/Thaw (F/T), (Room Temperature ((4° C.) and (50° C.)

| Resin | | F/T | | | |
|---|---|---|---|---|---|
| acid | Initial | Cycle | | Room | |
| value | Condition | 3 | 4° C. | Temp | 50° C.¹ |
| 778 | H/O | No | More | No | Formulation |
| | | Change | turbidity | Change | became darker. |
| 372 | H/O | No | Slightly | No | Formulation |
| | | Change | more turbid | Change | became darker. |
| 347 | H/O | No | No Change | No | Formulation |
| | | Change | | Change | became darker. |
| 244 | C/T | No | No Change | No | Formulation |
| | | Change | | Change | became darker. |
| 240 | C/T | No | No Change | No | Formulation |
| | | Change | | Change | became darker. |
| 226 | C/T | No | No Change | No | Formulation |
| | | Change | | Change | became darker. |
| 222 | C/T | No | No Change | No | Formulation |
| | | Change | | Change | became darker. |
| 221 | C/T | No | No Change | No | Formulation |
| | | Change | | Change | became darker. |
| 216 | C/T | No | No Change | No | Formulation |
| | | Change | | Change | became darker. |
| 214 | C/T | No | No Change | No | Formulation |
| | | Change | | Change | became darker. |
| 205 | C/T | No | No Change | No | Formulation |
| | | Change | | Change | became darker. |
| 75 | H/O | No | No Change | No | Formulation |
| | | Change | | Change | became darker. |
| | | | | | Some |
| | | | | | precipitation. |

¹Darkening of formulation due to formulation ingredients other than polymer

As Table 4 indicates, each of the Laundry Formulations including antiredeposition polymers having monomer contents in accordance with the present invention and having acid numbers ranging from 205 to 244 maintained their respective compatibility after three weeks in freeze/thaw cycles, freeze conditions, room temperature and in elevated temperature conditions.

### Example 3

### Evaluation of the Laundry Formulations of Examples 1 and 2 for Cleaning Performance

In Example 3, Laundry Formulation B from Table 1 above was used to evaluate the performance of various ARD polymers in preventing clay deposition (“antiredeposition”) onto various fabrics in top load washing machines. The procedure for evaluating the laundry formulations is a modification of ASTM 4008. Duplicate whiteness monitors were used in each wash. The monitors included the following fabrics:

Cotton 400

Cotton/Lycra 4301

Cotton/polyester blend (CFT7409)

EMPA 221 cotton

Nylon 365

Polyester 777

Terry cotton

TIC 361 nylon

T-shirt cotton (TF437W)

Preconditioned (with clay soil) ballast fabric (terry cotton towels and cotton/polyester sheets) was also included such that the total weight of fabric per wash was about 2.6 kg. Three antiredeposition cycles were performed using the same whiteness monitors in each cycle. In each cycle, 10 grams of loose Georgia Red Clay was included and the clay was dispersed into water and treated with a high-speed homogenizer before adding to the washing machines. The washing machines were model WTW4800XQ Whirlpool® Top Load Washers. Detergent dosage into each cycle was 24 grams (manufacturer recommended for single dose detergents) with test polymer incorporation level of 1% active material. Other washing conditions were 12 minute wash at 90° F. (32.2° C.), short rinse at ambient temperature (dictated by the machine setting), and Wyandotte city water hardness of 110 ppm (±5 ppm).

The quantitative assessment for antiredeposition was made by measuring the color change of the fabric before (L [symbol] , a [symbol] , b [symbol] ) and after (L [symbol] , a [symbol] , b [symbol] ) washing in the presence of the Georgia red clay. The L*, a*, and b* were made with the MACH 5 Multi Area Color-measurement Hardware from Colour Consult. The color difference, dE, was then calculated using the following relationship:

$$dE = \sqrt{{( L \text{?} - L \text{?} )}^{2} + {( a \text{?} - a \text{?} )}^{2} + {( b \text{?} - b \text{?} )}^{2}}$$

$$\text{?} \text{indicates text missing or illegible when filed}$$

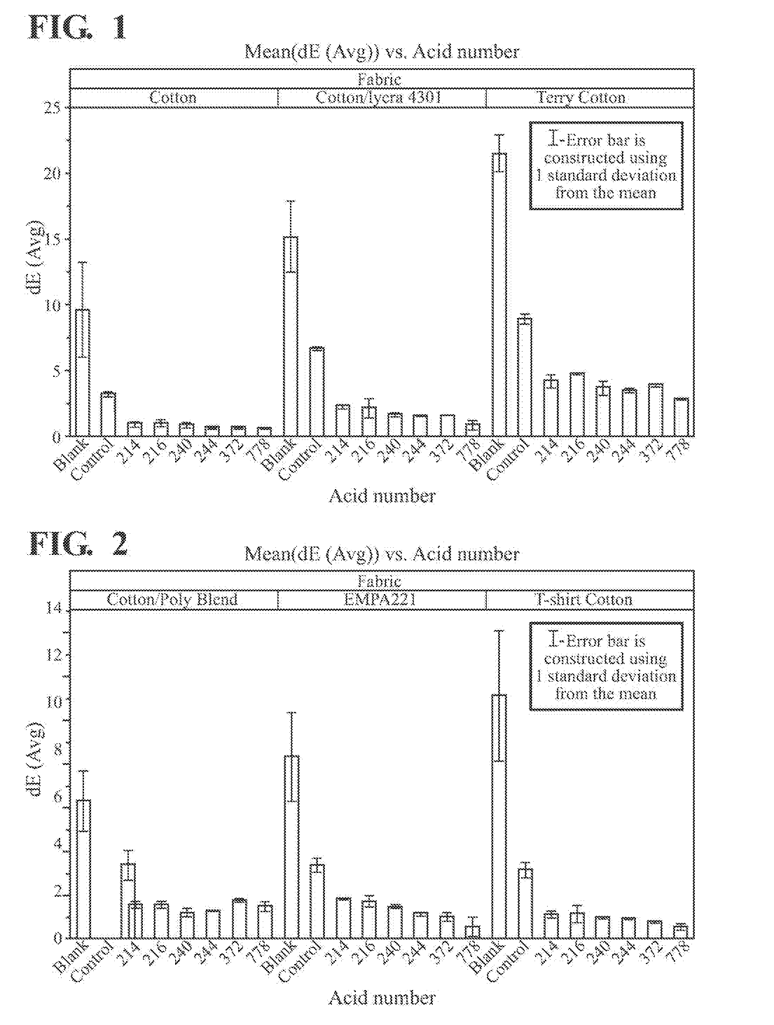

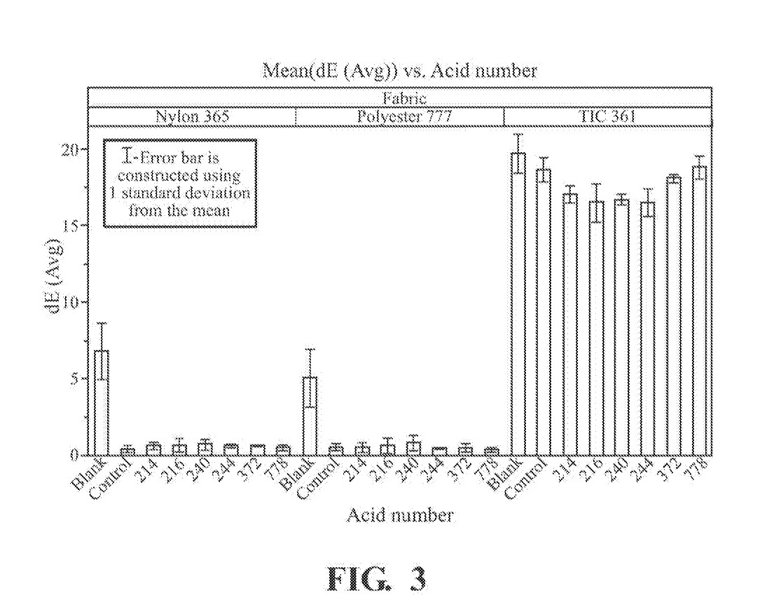

The color difference, dE, as illustrated in FIGS. 1-3 is an indication of the amount of buildup of Georgia red clay on the material tested. A lower dE value is an indication of less buildup of Georgia red clay on the material tested.

The results of this testing is shown in FIGS. 1-3, which illustrates that laundry compositions in accordance with the subject invention (and including the ARD polymers having monomeric contents in accordance with the subject invention and acid numbers, prior to neutralization, of from 214 to 372) provided improved cleaning performance, in terms of color difference (dE) on each of the fabrics as compared to the blank (only clay added, the control (no polymer added), and laundry compositions including an antiredeposition polymer having an acid number of 778 prior to neutralization.

It is to be understood that the appended claims are not limited to express and particular compounds, surface treatment materials, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the subject invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the subject invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The invention has been described in an illustrative manner, and it is to be understood that the terminology which has been used is intended to be in the nature of words of description rather than of limitation. Obviously, many modifications and variations of the subject invention are possible in light of the above teachings. The invention may be practiced otherwise than as specifically described.

1. A concentrated liquid detergent comprising, based on the total amount of the concentrated liquid detergent:
(a) 0.1 to 10 weight percent of an antiredeposition polymer comprising the reaction product of, based on the total amount of the antiredeposition polymer:
(1) 25 to 60 weight percent of at least one (meth)acrylic acid monomer, and
(2) 40 to 75 weight percent of at least one radically-polymerizable monomer having radically polymerizable groups selected from a linear α-olefin, a branched α-olefin, a styrenic monomer, a vinyl or allylic ether monomer, an ethylenic monomer, a (meth)acrylate monomer and combinations thereof;
(b) 30 to 70 weight percent of at least one surfactant;
(c) 5 to 69.9 weight percent of at least one solvent other than water; and
(d) 0 to 20 weight percent water.

2. The concentrated liquid detergent according to claim 1, wherein the reaction product further comprises:
(3) greater than 0 to 16 weight percent of at least one monomer of maleic anhydride, said at least one monomer of maleic anhydride being ring-opened after polymerization with a hydroxide ion.

3. The concentrated liquid detergent according to claim 1, wherein (a) the antiredeposition polymer has a weight average molecular weight ranging from 1,000 to 100,000 g/mole (Daltons), as measured by gel permeation chromatography.

4. The concentrated liquid detergent according to claim 3, further comprising:
(e) a neutralizing agent added in an amount sufficient to neutralize each carboxylic acid group contributed from the at least one (meth)acrylic acid monomer.

5. The concentrated liquid detergent according to claim 4, wherein (e) the neutralizing agent is selected from sodium hydroxide, potassium hydroxide, ammonia, ammonium hydroxide, monoethanolamine, triethanolamine, and combination thereof.

6. The concentrated liquid detergent according to claim 2, wherein (a) the antiredeposition polymer has a weight average molecular weight ranging from 1,000 to 100,000 g/mole (Daltons), as measured by gel permeation chromatography.

7. The concentrated liquid detergent according to claim 6, further comprising:
(e) a neutralizing agent added in an amount sufficient to neutralize each carboxylic acid group contributed from the at least one (meth)acrylic acid monomer and to ring open said at least one monomer of maleic anhydride.

8. The concentrated liquid detergent according to claim 7, wherein (e) the neutralizing agent is selected from sodium hydroxide, potassium hydroxide, ammonium hydroxide, and any combination thereof.

9. The concentrated liquid detergent according to claim 1, wherein (d) water is present in the concentrated liquid detergent in an amount ranging from 0.1 and 20 weight percent based on the total weight of the concentrated liquid detergent.

10. The concentrated liquid detergent according to claim 4, wherein the acid number of the antiredeposition polymer, prior to being mixed with components (b)-(d) and prior to being neutralized with the neutralizing agent (e), ranges from 50 to 500 mg KOH.

11. The concentrated liquid detergent according to claim 10, wherein the acid number of the antiredeposition polymer, prior to being mixed with components (b)-(d) and prior to being neutralized with the neutralizing agent (e), ranges from 75 to 450 mg KOH.

12. The concentrated liquid detergent according to claim 11, wherein the acid number of the antiredeposition polymer, prior to being mixed with components (b)-(d) and prior to being neutralized with the neutralizing agent (e), ranges from 150 to 425 mg KOH.

13. The concentrated liquid detergent according to claim 12, wherein the acid number of the antiredeposition polymer, prior to being mixed with components (b)-(d) and prior to being neutralized with the neutralizing agent (e), ranges from 200 to 400 mg KOH.

14. The concentrated liquid detergent according to claim 13, wherein the acid number of the antiredeposition polymer, prior to being mixed with components (b)-(d) and prior to being neutralized with the neutralizing agent (e), ranges from 205 to 372 mg KOH.

15. A method for forming a concentrated liquid detergent, the method comprising:
(a) forming an antiredeposition polymer comprising the reaction product of, based on the total amount of the antiredeposition polymer:
(1) 25 to 60 weight percent of at least one (meth)acrylic acid monomer, and
(2) 40 to 75 weight percent of at least one radically-polymerizable monomer having radically polymerizable groups selected from a linear α-olefin, a branched α-olefin, a styrenic monomer, a vinyl or allylic ether monomer, an ethylenic monomer, a (meth)acrylate monomer, and combinations thereof;
(b) neutralizing the formed antiredeposition polymer with a neutralizing agent; and
(c) combining 0.1 to 10 weight percent of said neutralized antiredeposition polymer with 30 to 70 weight percent of at least one surfactant; 5 to 69.9 weight percent of at least one solvent other than water; and 0 to 20 weight percent water.

16. A method for forming a concentrated liquid detergent, the method comprising:
(a) forming an antiredeposition polymer comprising the reaction product of, based on the total amount of the antiredeposition polymer:
(1) 25 to 60 weight percent of at least one (meth)acrylic acid monomer, and
(2) 40 to 75 weight percent of at least one radically-polymerizable monomer having radically polymerizable groups selected from a linear α-olefin, a branched α-olefin, a styrenic monomer, a vinyl or allylic ether monomer, an ethylenic monomer, a (meth)acrylate monomer, and combinations thereof;
(3) at least one monomer of maleic anhydride present in an amount ranging from 0 to 16 weight percent of the reaction product;
(b) neutralizing the formed antiredeposition polymer with a neutralizing agent; and
(c) combining 0.1 to 10 weight percent of said neutralized antiredeposition polymer with 30 to 70 weight percent of at least one surfactant; 5 to 69.9 weight percent of at least one solvent other than water; and 0 to 20 weight percent water.

17. The method according to claim 15, wherein the neutralizing agent is added in an amount sufficient to neutralize each carboxylic acid group contributed from the at least one (meth)acrylic acid monomer.

18. The method according to claim 17, wherein the neutralizing agent is selected from sodium hydroxide, potassium hydroxide, ammonia, ammonium hydroxide, monoethanolamine, triethanolamine, and any combination thereof.

19. The method according to claim 16, wherein the neutralizing agent is added in an amount sufficient to neutralize each carboxylic acid group contributed from the at least one (meth)acrylic acid monomer and to ring open each of said at least one monomer of maleic anhydride.

20. The method according to claim 19, wherein the neutralizing agent is selected from sodium hydroxide, potassium hydroxide, ammonia, ammonium hydroxide, monoethanolamine, triethanolamine, and any combination thereof.

21. The method according to claim 15, wherein water is present in the concentrated liquid detergent in an amount ranging from 0.1 and 20 weight percent based on the total weight of the concentrated liquid detergent.

22. The method according claim 15, wherein the formed antiredeposition polymer has a weight average molecular weight ranging from 1,000 to 100,000 g/mole (Daltons), as measured by gel permeation chromatography.

23. The method according to claim 15, wherein the acid number of the formed antiredeposition polymer of step (a) ranges from 75 to 450 mg KOH.
